(19) United States
(12) Patent Application Publication
(10) Pub. No.: US 2026/0147159 A1
(43) Pub. Date: May 28, 2026

(54) METHOD AND APPARATUS FOR REDUCING OPTICAL INTERFERENCE IN AN OPTICAL MODEM

(71) Applicant: CIENA CORPORATION, Hanover, MD (US)

(72) Inventors: Scott Kuntze, Ottawa (CA); Ian Betty, Ottawa (CA); Michael Vitic, Chelsea (CA); Ronald Hartman, Fitzroy Harbour (CA)

(73) Assignee: CIENA CORPORATION, Hanover, MD (US)

(21) Appl. No.: 18/960,513

(22) Filed: Nov. 26, 2024

(51) Int. Cl. G02B 6/293; G02B 6/12; H04B 10/077; H04B 15/00

(52) U.S. Cl. CPC G02B 6/29395; G02B 6/12007; H04B 10/0775; H04B 15/00

(57) ABSTRACT

Aspects of the subject disclosure may include, for example, an optical modem that includes a tunable optical separator that separates optical signals into distinct wavelengths, resulting in a first optical signal with a first wavelength and a second optical signal with a second wavelength. A controller detects crosstalk between these signals due to operational variances in the tunable optical separator and performs adjustments to the tunable optical separator to reduce crosstalk. Other embodiments are disclosed.

### FIELD OF THE DISCLOSURE

The subject disclosure relates to a method and apparatus for reducing optical interference in an optical modem. Such interference may be caused by, for example, environmental factors that adversely affect the performance of the optical modem.

### BACKGROUND

Optical modems often enhance data transmission capabilities through advanced modulation techniques. In some cases, modems may further enhance data transmission by transmitting and receiving on multiple wavelengths simultaneously. These modems separate incoming optical signals into distinct wavelengths, directing each to corresponding receivers. Variations in, for example, manufacturing, temperature fluctuations, aging, mechanical stresses, or other environmental factors can affect the performance of the optical modem, leading to suboptimal optical signal separation resulting in increased interference.

Existing solutions may not adequately address these challenges, resulting in signal loss and degraded performance. The need therefore arises for dynamically improving signal separation to compensate for such environmental factors adversely affecting the overall efficiency and reliability of the optical modem.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of an optical modem in accordance with various aspects described herein.

FIG. 2A is a block diagram illustrating an exemplary, non-limiting embodiment of an optical modem in accordance with various aspects described herein.

FIG. 2B is a block diagram illustrating an exemplary, non-limiting embodiment of the demultiplexer controller of FIG. 2A in accordance with various aspects described herein.

FIGS. 3A and 3B depict plots illustrating exemplary, non-limiting embodiments depicting operations of a demultiplexer controller in the optical modem of FIGS. 1, 2A and 2B in accordance with various aspects described herein.

FIG. 4 is a block diagram illustrating an exemplary, non-limiting embodiment of an optical modem in accordance with various aspects described herein.

FIG. 5 depicts an illustrative embodiment of a method utilized by an optical modem in accordance with various aspects described herein.

### DETAILED DESCRIPTION

The subject disclosure describes, among other things, illustrative embodiments for enhancing performance of an optical modem that is subjected to component variances that can lead to optical interference and thereby degradation in performance. Other embodiments are described in the subject disclosure below.

One or more aspects of the subject disclosure can include enhancing signal separation in a coherent modem receiver by employing a tunable wavelength demultiplexer. The tunable wavelength demultiplexer receives optical signals and separates them into distinct wavelengths. A demultiplexer controller detects crosstalk between the separated optical signals and performs phase shift adjustments to the tunable wavelength demultiplexer to minimize interference and maximize signal clarity.

One or more aspects of the subject disclosure include the demultiplexer controller monitoring control signals from amplifiers associated with each wavelength of the optical signals produced by a tunable wavelength demultiplexer. By assessing these control signals, the demultiplexer controller determines when a steady-state condition is achieved, allowing for adjustments to the demultiplexer controller within an appropriate range of operation of the optical modem. This ensures that the tunable wavelength demultiplexer operates optimally, even in the face of manufacturing variances, temperature fluctuations, aging effects, or other environmental variances that can adversely affect the operations of the tunable wavelength demultiplexer.

One or more aspects of the subject disclosure include the demultiplexer controller monitoring detection signals supplied by the amplifiers to guide the phase shift adjustments. This approach focuses on increasing the output of each wavelength, further enhancing the accuracy and efficiency of the signal separation process.

One or more aspects of the subject disclosure includes a method performed by an optical modem for receiving optical signals at a tunable wavelength demultiplexer, separating the optical signals into distinct wavelengths resulting in a first optical signal having a first wavelength and a second optical signal having a second wavelength, detecting crosstalk between the first optical signal and the second optical signal by a demultiplexer controller in response to a variance in the operation of the tunable wavelength demultiplexer, and performing a phase shift adjustment of the tunable wavelength demultiplexer by the demultiplexer controller to reduce the crosstalk.

One or more aspects of the subject disclosure include an optical modem that includes a tunable optical separator and a controller. The tunable optical separator is configured to separate optical signals into distinct wavelengths, resulting in a first optical signal having a first wavelength and a second optical signal having a second wavelength. The controller performs operations including detecting crosstalk between the first and second optical signals caused by a variance in the operation of the tunable optical separator and performing an adjustment of the tunable optical separator to reduce the crosstalk.

One or more aspects of the subject disclosure include a non-transitory machine-readable medium having executable instructions that, when executed by a processing system including a processor, facilitate operations. These operations include detecting crosstalk between a first optical signal and a second optical signal produced by a tunable wavelength demultiplexer that separates optical signals into distinct wavelengths and applying a phase shift adjustment to reduce the crosstalk. Crosstalk can be attributed to a variance in the operation of the tunable wavelength demultiplexer.

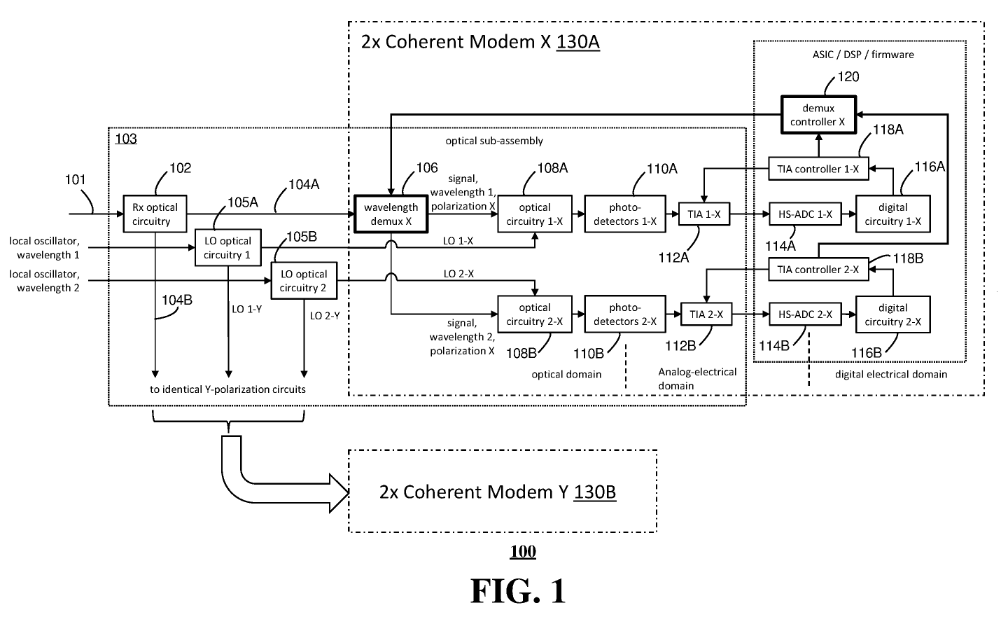

FIG. 1 is a block diagram illustrating an exemplary, non-limiting embodiment of an optical modem 100 in accordance with various aspects described herein. Viewing FIG. 1 from left to right, an optical line 101 is supplied to a receive (RX) optical circuitry 102. The optical line 101 has dual-polarization with a transverse-electric component and a transverse-magnetic component each having two wavelengths (wavelengths 1 & 2). The RX optical circuitry 102 is configured to generate from the transverse-electric component a first transverse-electric optical signal 104A that is supplied to a two-by (2x) coherent optical modem X 130. The X labels depicted in the components of the 2x coherent optical modem X 130 represent processing of a first polarization path associated with the first transverse-electric optical signal 104A.

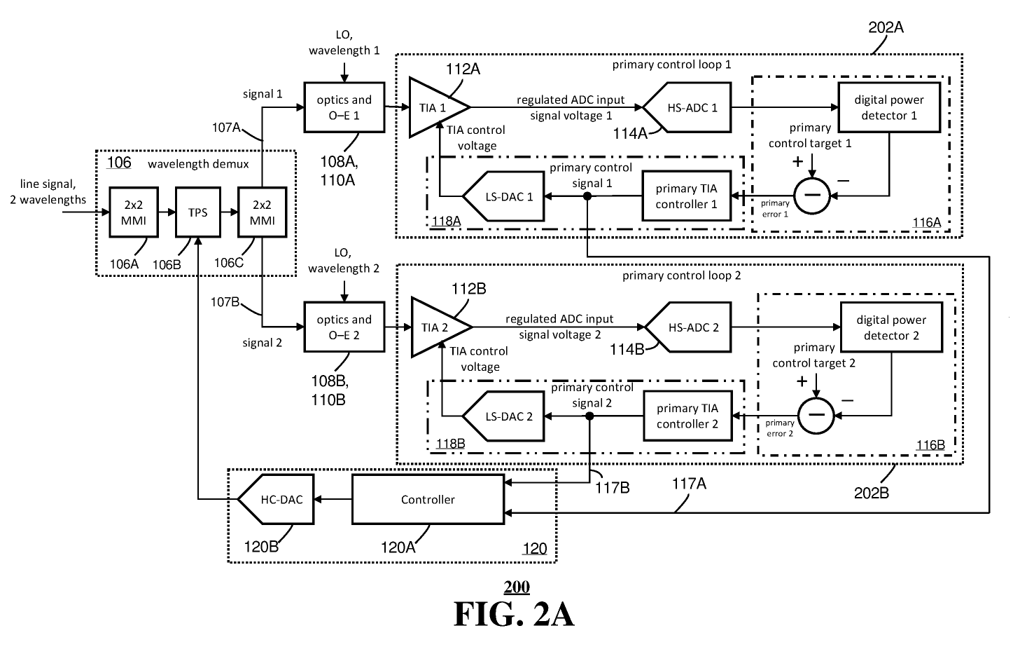

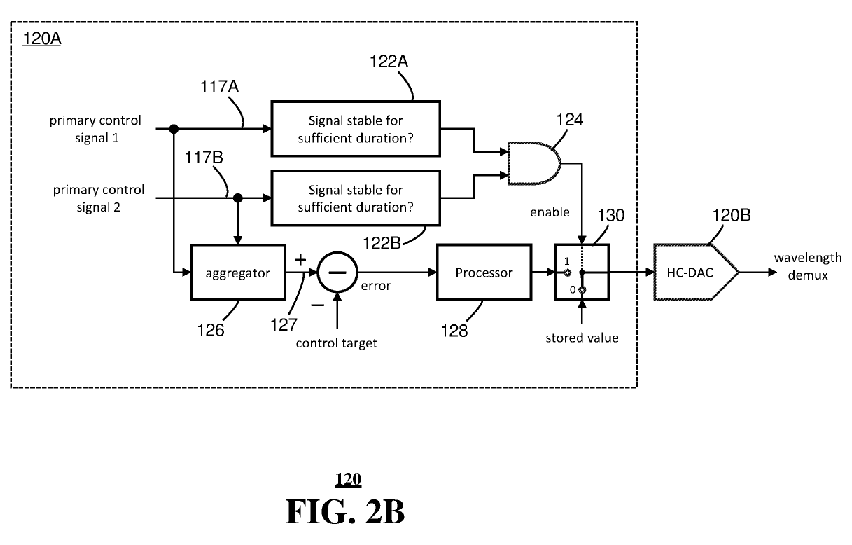

The RX optical circuitry 102 is further configured to generate from the transverse-magnetic component a second transverse-electric optical signal 104B supplied to a 2x coherent optical modem Y 130. Similarly, the Y label used for the 2x coherent optical modem Y 130 represents processing of the second transverse-electric optical signal 104B by components of the 2x coherent optical modem Y 130. Although not shown, the 2x coherent optical modem Y 130 includes a second instance of the same components as the 2x coherent optical modem X 130. To simplify the illustrations, the components of the 2x coherent optical modem Y 130 are not shown in FIG. 1 or in the descriptions associated with FIGS. 2A, 2B, 3A, 3B, and 4. It will be appreciated, however, that the functional descriptions provided below for the 2x coherent optical modem X 130 can be applied to the 2x coherent optical modem Y 130.

Referring back to the 2x coherent modem X 130A, this receiver includes a demultiplexer controller X 120 that optimizes a tunable wavelength demultiplexer X 106 coupled to two distinct coherent receivers covering paths labeled 1-X and 2-X, respectively. In one embodiment, the wavelength demultiplexer X 106 can represent an integrated, polarization-diverse tunable wavelength demultiplexer that sends the appropriate signal wavelength to each coherent receiver (i.e., wavelength 1 to the 1-X coherent receiver path and wavelength 2 to the 2-X coherent receiver path). Integrating the wavelength demultiplexer 106 into an optical sub-assembly 103 reduces total modem cost, complexity, and size.

The optical signals at wavelengths 1 and 2 are supplied to optical circuitry 108A and 108B which mixes these signals with a local oscillator of its corresponding wavelength (LO 1-X and LO 2-X supplied by LO optical circuitry 105A and 105B) and converts them to the electrical domain via photodetectors 110A and 110B. Transimpedance amplifiers (TIAs) 112A and 112B convert resulting signal photocurrents supplied by the photodetectors 110A and 110B to voltages sampled by high-speed analog-to-digital converters (HS-ADCs) 114A and 114B. Digital circuits 116A and 116B measure signal power, which is supplied to TIA controllers 118A and 118B to control gain of the TIAs 112A and 112B and thereby regulate HS-ADCs 114A and 114B input voltages in their respective primary control loops. The demultiplexer controller X 120, operating as secondary control loop, measures signals of each primary control loop and adjusts the wavelength demultiplexer X 106 to maximize the output power of each wavelength while reducing crosstalk from one wavelength to another.

Although not shown, it will be appreciated that the photodetectors 110A and 110B, TIAs 112A and 112B, HS-ADCs 114A and 114B, digital circuits 116A and 116B, and TIA controllers 118A and 118B are configured to process quadrature (Q) and inphase (I) components of the signals supplied by the optical circuitry 108A and 108B. To simplify illustrations, the Q and I paths have not been shown. It is also noted that standard broadband optical power monitors in the demultiplexed signal paths described above are insufficient to mitigate degradation in the wavelength demultiplexer X 108 (due to environmental factors as will be described below) because they measure total power of both wavelengths together, so they are blind to any sub-optimal demultiplexing. Thus, any wavelength-specific detection can only occur after LO-mixing and limited-bandwidth filtering.

Typically, the tunable wavelength demultiplexer X 106 uses multimode interference (MMI) or similar structures to separate and divert the two wavelengths. Variations in manufacturing (actual width, etch depth, etc.), temperature in the field, or over life (e.g., due to mechanical stress and relaxation) can adversely affect the performance of the MMI to fully separate optical signals in their corresponding wavelengths. This in turn can cause drift in the tunable wavelength demultiplexer X 106. When the tunable wavelength demultiplexer X 106 is not optimal it imperfectly partitions the wavelengths, thereby sending some of each optical signal to a wrong photodetector (i.e., crosstalk) and losing that amount of signal from the proper photodetector. In loss-limited links this signal loss leads to reduced optical link reach and degraded modem performance. In addition, while each receiver path is tuned by its own LO and bandwidth, some signal from the wrong wavelength does arrive at the HS-ADC input and further degrades performance as an equivalent crosstalk noise term. As will be shown, the demultiplexer controller X 120 can be configured to monitor the primary control loops of the 2x coherent modem X 130 and tune the tunable wavelength demultiplexer X 106 so that the maximum amount of each wavelength signal travels to its proper receiver. In this configuration, the demultiplexer controller X 120 serves as a secondary control loop that tunes the tunable wavelength demultiplexer X 106 to re-optimize the output of each wavelength.

FIG. 2A is a block diagram illustrating an exemplary, non-limiting embodiment of an optical modem 200 in accordance with various aspects described herein. In this embodiment, the tunable wavelength demultiplexer X 106 comprises a first 2x2 MMI 106A coupled to a thermal phase shifter (TPS) 106B followed by a second 2x2 MMI 106C. The first and second MMIs 106A and 106C are configured to separate the optical signals according to their respective wavelengths into first and second optical signals 107A and 107B. The optical signal 107A at wavelength 1 is supplied to an Optics and O-E (optical to electrical) block, which can incorporate the optical circuitry and photodetectors 108A and 110A of FIG. 1 for the 1-X path (at wavelength 1). The Optics and OE block 108A, 110A supplies photocurrents to TIA 112A, which in turn converts such currents to voltages sampled by HS-ADC 114A. Digital circuit 116A measures signal power utilizing a digital power detector, which is supplied to TIA controller 118A to control gain of TIA 112A and thereby regulate HS-ADCs 114A input voltage. The digital circuit 116A includes an error signal and primary control target signal to minimize error in a first primary control loop 202A, which includes TIA 112A, HS-ADC 114A, digital circuit 116A and TIA controller 118A.

Similarly, the optical signal 107B at wavelength 2 is supplied to an Optics and O-E (optical to electrical) block, which incorporates the optical circuitry and photodetectors 108B and 110B of FIG. 1 for the 2-X path (at wavelength 2). The Optics and OE block 108B, 110B supplies photocurrents to TIA 112B, which in turn converts such currents to voltages sampled by HS-ADC 114B. Digital circuit 116B measures signal power utilizing a digital power detector, which is supplied to TIA controller 118B to control gain of TIA 112B and thereby regulate HS-ADCs 114B input voltage. The digital circuit 116B includes an error signal and primary control target signal to minimize error in a second primary control loop 202B, which includes TIA 112B, HS-ADC 114B, digital circuit 116B and TIA controller 118B.

As noted earlier, the first and second MMIs 106A and 106C can be adversely affected by environmental conditions, which can cause the tunable wavelength demultiplexer X 106 to drift thereby resulting in a sub-optical separation of the optical signals causing crosstalk. To mitigate crosstalk, the demultiplexer controller X 120 can be configured to operate as secondary control loop that measures signals from the first primary control loop 202A and the second primary control loop 202B and makes adjustments to the wavelength demultiplexer X 106 to maximize the output power of each wavelength while reducing crosstalk from one wavelength to another. To accomplish this, the demultiplexer controller X 120 utilizes a controller 120A (e.g., microcontroller, DSP, or custom ASIC) and a high-current DAC (HC-DAC) 120B.

In operation, the primary control loops 202A and 202B measure HS-ADC 114A and 114B input power, compute via the digital circuits 116A and 116B an error signal against primary control target signals relating to desired HS-ADC input levels for producing first and second primary control signals 117A and 117B from the TIA controllers 118A and 118B in order to minimize the primary error in each of the primary control loops 202A and 202B. The primary control target signals shown in the digital circuits 116A and 116B can be calibrated at time of manufacturing the optical modem 100 and can be adjusted during modem operation via firmware and/or hardware according to field temperature, age, characteristics of the optical signal being received (e.g., its format and/or levels), bandwidth of the optical signals, or other factors.

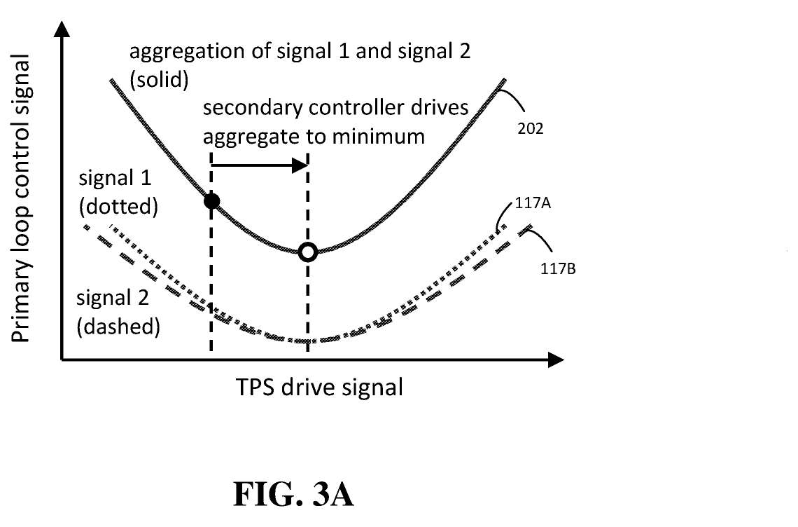

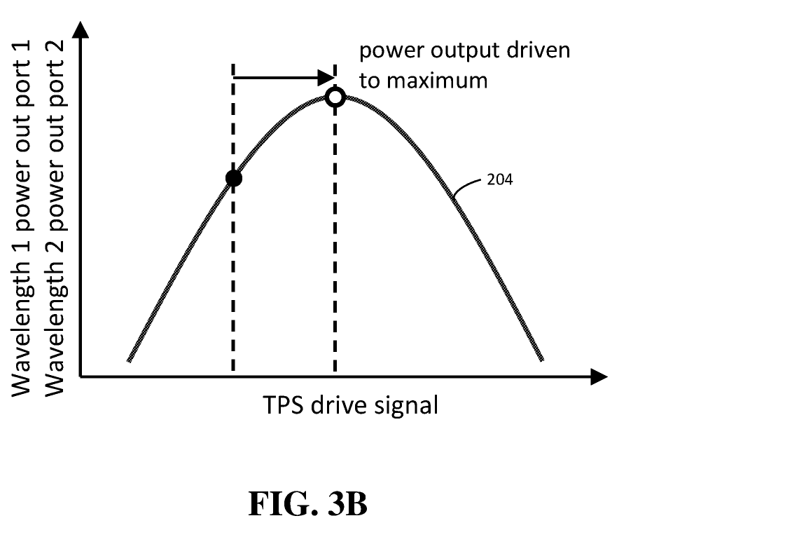

Referring back to the demultiplexer controller X 120, it monitors the first and second primary control signals 117A and 117B from the primary control loops 202A and 202B because these signals are proportional to the TIA gain needed to amplify each 2x coherent receiver’s own signal (i.e., at the appropriate wavelength). The first and second primary control signals 117A and 117B can be used by the demultiplexer controller X 120 to inversely measure the amount of optical power in each signal at the appropriate wavelength. The demultiplexer controller X 120 then drives a tuning element in the tunable wavelength demultiplexer X 106 to minimize an aggregation of the first and second primary control signals 117A and 117B—see FIG. 3A. In the embodiment of FIG. 2A, the tuning element of the tunable wavelength demultiplexer X 106 is the TPS 106B driven by the HC-DAC 120B of the demultiplexer controller X 120. It will be appreciated that the tuning element can also be represented by a carrier injection phase shifter, electrooptic phase shifter, carrier depletion phase shifter, or combinations thereof. Accordingly, other configurations of the tuning element are contemplated by the subject disclosure.

The aggregation is typically the sum of the first and second primary control signals 117A and 117B. In other embodiments, the aggregation can correspond to another function that instead computes the maximum, weighted average, or some other aggregating operation. To avoid optical transients from the optical line 101, the demultiplexer controller X 120 can be configured to engage only when it determines that the primary control loops 202A and 202B are in steady-state mode of operation so that the demultiplexer controller X 120 does not erroneously detune the tunable wavelength demultiplexer X 106.

FIG. 2B is a block diagram illustrating an exemplary, non-limiting embodiment of the demultiplexer controller X 120 of in FIG. 2A in accordance with various aspects described herein. FIG. 2B depicts the controller 120A of FIG. 2A comprising first and second blocks 122A and 122B (implemented in hardware and/or firmware) that monitor signal stability for a sufficient duration in the first and second primary control signals 117A and 117B. Signal stability is achieved when the first and second primary control signals 117A and 117B maintain reasonably constant values (e.g., within a predefined tolerance) over a sufficient duration in time leading up to an instance in time that the first and second blocks 122A and 122B decide to engage the demultiplexer controller X 120. If both the first and second primary control signals 117A and 117B achieve a steady-state condition a Boolean AND detector 124 is triggered thereby enabling operations of the demultiplexer controller X 120. Aggregation of the first and second primary control signals 117A and 117B is performed by an aggregator 126 which is compared to a control target that relates to a desired value of the first and second primary control signals 117A and 117B and that can be calibrated during manufacture of the optical modem 100 and can be adjusted via firmware and/or hardware based on field temperature, age or other environment factors. A processor 128 (e.g., microcontroller or other suitable computing device) is configured to perform the above-described operations of the demultiplexer controller X 120. The demultiplexer controller X 120 can also be configured to monitor other locations of the primary control loops 202A and 202B for signal integrity. The demultiplexer controller X 120 may also dither the TPS signal or obtain from firmware (operating from one or more DSP controllers in) the one or more of the 2x coherent receiver paths spectral tilt to detect slope (i.e., which side of the optimum shown in FIG. 3B as determined by the controller 120A) and adjust gain of the TIAs 112A and 112B accordingly.

Additionally, the demultiplexer controller X 120 may also check optical power monitors or TIA front-end electronic received signal strength indicators (RSSIs) to ensure there is light incident on the optical modem 100. The underlying DSP controller(s) mentioned above may be, for example, a PID (Proportional-Integral Derivative controller), LQR (Linear Quadratic Regulator controller), or similar controller that drives to a control target set below the expected aggregation in FIG. 3A and may be implemented in the digital and/or analog domains. In another embodiment, a starting TPS drive level may be calibrated during manufacturing or stored from previous optimal operation to seed a controller of the optical modem 100 at start-up by way of a memory element of block 130 shown in FIG. 2B. Before the demultiplexer controller X 120 starts, it can be configured to store the present value of the HC-DAC 120B in the memory element of block 130 in case one or both of the primary control loops 202A and 202B suddenly jumps due to a transient event on the optical line 101. In this case the demultiplexer controller X 120 halts and writes that stored value back to the HC-DAC 120B so that the secondary loop cannot become confused or erroneously detune the tunable wavelength demultiplexer 106.

FIGS. 3A and 3B depict plots illustrating exemplary, non-limiting embodiments depicting operations of the demultiplexer controller X 120 of FIGS. 1, 2A and 2B in accordance with various aspects described herein. FIG. 3A illustrates how once the primary control loops 202A and 202B stabilize, the demultiplexer controller X 120 adjusts the TPS drive signal until the aggregated first and second primary control signals 117A and 117B (depicted as signal 127 in FIG. 2B, which is proportional to RF gain) reaches its minimum. A minimum control signal implies minimum RF gain needed in the signal paths 1-X and 2-X, which implies maximum power output of each of the wavelength signals from the tunable wavelength demultiplexer 106. FIG. 3B shows that changing the TPS drive changes the wavelength tuning of the tunable wavelength demultiplexer 106, which, in turn, changes the amount of power of each wavelength out of each port. There is an optimum value of the TPS drive signal that maximizes the power of both wavelengths out of their respective ports.

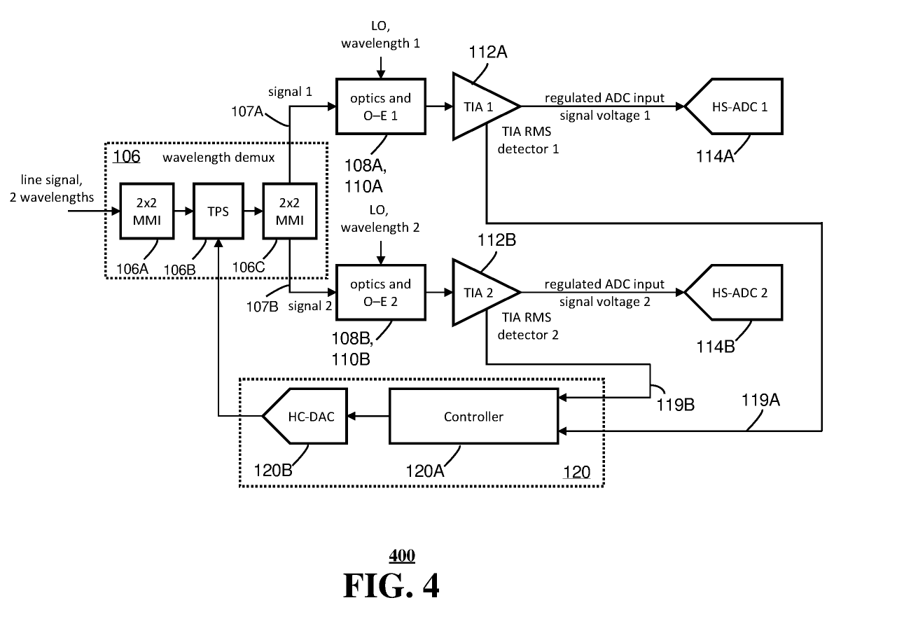

FIG. 4 is a block diagram illustrating an exemplary, non-limiting embodiment of an optical modem 400 in accordance with various aspects described herein. In the optical modem 400 of FIG. 4 the secondary loop, operated by the demultiplexer controller X 120, monitors detection signals 119A and 119B supplied by the TIAs 112A and 112B. The detection signals 119A and 119B can be supplied by root-mean-squared (RMS) power detection circuitry integrated in the TIAs 112A and 112B. An RF RMS power detector in a TIA for optical networks can be part of an analog primary gain control loop that regulates downstream HS-ADC voltage at the TIA, and is an alternate control approach to the digital circuits 116A and 116B of FIGS. 1 and 2A (hence, why the digital circuits 116A and 116B of FIGS. 1 and 2A are not shown in the embodiment of FIG. 4). An RMS power detector can use a diode-based rectifier that generates a DC voltage signal proportional to a main data path AC signal. A drawback of this type of power detector is that it must be AC-coupled to the data path, which results in unwanted data path spectral shaping, and possible control errors if the peak-to-peak-to-RMS ratio changes in the primary signal. To mitigate these issues, the demultiplexer controller X 120 can be configured to maximize the input control signal by driving the TPS 106B to maximize the correct wavelength out of each port.

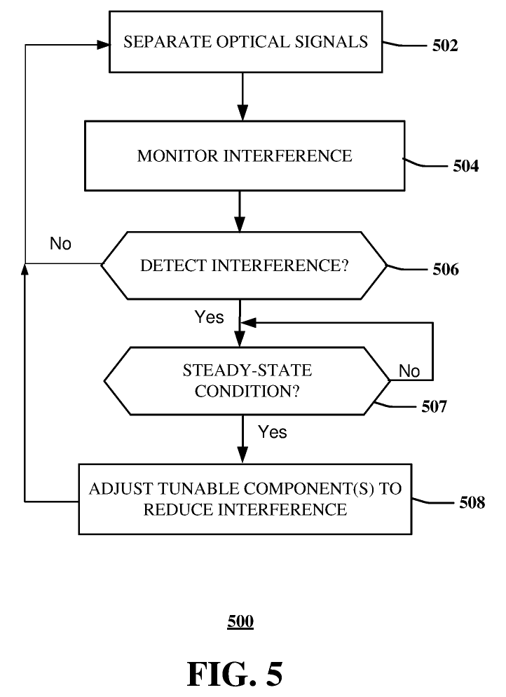

FIG. 5 depicts an illustrative embodiment of a method 500 utilized by an optical modem in accordance with various aspects described herein. In step 502 the optical modem is configured to separate optical signals into distinct wavelengths using an optical separator. At step 504 the optical modem monitors for interference, specifically crosstalk, between these separated optical signals. In step 506, the optical modem checks if interference is detected. The optical modem detects interference by monitoring primary control loops in optical paths N-by coherent receivers of the optical modem. Accordingly, the monitoring process in step 504 serves as a secondary control loop. If interference is present, at step 507, the optical modem checks that there is sufficient stability in the primary control loops to proceed with an adjustment under a steady-state condition. Such as steady-state condition can be achieved when, for example, the primary control loops in optical paths N-by coherent receivers are in steady-state mode of operation so that the secondary control loop does not erroneously detune a demultiplexer. If such stability is not achieved, step 507 loops back on itself until such a condition is present. When stability is achieved, at step 508 the optical modem performs an adjustment to tunable components of the optical separator to reduce the interference. The adjustment can correspond to a phase adjustment and/or other suitable adjustments that can be made to an optical separator to improve separation of the optical signals according to their corresponding wavelengths. This adjustment ensures optimal signal separation and minimal crosstalk, enhancing the performance and reliability of the optical modem. The process continuously loops to maintain optimal conditions, addressing variances such as manufacturing differences, temperature changes, aging effects, or other environmental factors that may arise.

While for purposes of simplicity of explanation, the respective processes are shown and described as a series of blocks in FIG. 5, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

The embodiments described above and depicted in FIGS. 1, 2A, 2B, 3A, 3B, 4 and 5 reduce assembly complexity and total optical modem cost. These embodiments mitigate adverse effects the associated MMI (or similar) structures are subject to due to manufacturing variances, aging shifts, temperature changes, and mechanical stress (e.g., vibration). These variances degrade demultiplexing performance and thereby degrade optical modem performance by reducing the appropriate signal into each receiver of the optical modem and increasing noise by diverting some of the wrong signal into each receiver. The aforementioned embodiments actively tune a tunable optical separator such as a wavelength demultiplexer to ensure that a maximum amount of each optical signal is separated according to its corresponding wavelength and thus optimizes receiver performance by minimizing the sum of control signals from the primary control loops that regulate high-speed ADC input levels.

It is further noted that the embodiments of the subject disclosure can scale up to N-by modems. Although the wavelength tunable wavelength demultiplexer structure for an N-by modem may increase in complexity, the underlying control embodiments described in the subject disclosure can be applied in the same or at least similar manner. It will be further appreciated that the embodiments of the subject disclosure can be further adapted to other embodiments that achieve similar results. For example, the tunable wavelength demultiplexer described above can be replaced by other devices that can similarly perform separation of optical signals according to their wavelength and which can be adapted to be tuned by the demultiplexer controller 120. Such other devices can include but are not limited to arrayed waveguide gratings, thin-film filters, external cavity, Fabry-Perot Tunable Filters, echelle gratings, diffraction gratings, fiber bragg gratting, or combinations thereof. These devices can serve as tunable optical separators adapted to be tunable through mechanisms like thermal tuning, electro-optic effects, or mechanical adjustments, enabling control over the wavelength separation process by the demultiplexer controller 120 described in the subject disclosure. Accordingly, increasing scalability to an N-by modem, utilizing other tunable optical separators, and other suitable adaptations are contemplated by the subject disclosure. Additionally, the embodiments of the subject disclosure can be adapted to non-coherent and/or single polarization embodiments of the N-by modems.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data. Computer-readable storage media can comprise the widest variety of storage media including tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

In addition, a flow diagram may inherently include a “start” and/or “continue” indication, which may not be shown (e.g., a power-on state of the disclosed embodiments). The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A method performed by an optical modem, comprising:
receiving, by a tunable wavelength demultiplexer, a portion of processed optical signals supplied by an optical receiver circuit;
separating, by the tunable wavelength demultiplexer, the portion of the processed optical signals into distinct wavelengths resulting in a first optical signal having a first wavelength and a second optical signal having a second wavelength;
detecting, by a demultiplexer controller, crosstalk between the first optical signal and the second optical signal responsive to a variance in an operation of the tunable wavelength demultiplexer; and
performing, by the demultiplexer controller, a phase shift adjustment of the tunable wavelength demultiplexer to reduce the crosstalk.

2. The method of claim 1, further comprising supplying the first optical signal having the first wavelength to a first receiver of the optical modem and the second optical signal having the second wavelength to a second receiver of the optical modem.

3. The method of claim 2, wherein the performing comprises:
monitoring, by the demultiplexer controller, a first control signal directed to a first transimpedance amplifier (TIA) associated with the first receiver;
monitoring, by the demultiplexer controller, a second control signal directed to a second TIA associated with the second receiver;
determining, by the demultiplexer controller, a stability state of the first control signal and the second control signal; and
performing, by the demultiplexer controller, the phase shift adjustment of the tunable wavelength demultiplexer when the stability state indicates a steady-state condition has been reached.

4. The method of claim 3, wherein the first receiver comprises a first coherent receiver, wherein the second receiver comprises a second coherent receiver, and wherein the steady-state condition is reached when the first control signal and the second control signal remain within a predetermined range for a specified duration.

5. The method of claim 2, wherein the performing comprises:
receiving, by the demultiplexer controller, a first detection signal from a first transimpedance amplifier (TIA) associated with the first receiver;
receiving, by the demultiplexer controller, a second detection signal from a second TIA associated with the second receiver; and
performing, by the demultiplexer controller, the phase shift adjustment of the tunable wavelength demultiplexer according to the first detection signal and the second detection signal.

6. The method of claim 1, wherein the tunable wavelength demultiplexer comprises one or more devices that separate the portion of the processed optical signals to produce the first optical signal having the first wavelength and the second optical signal having the second wavelength.

7. The method of claim 6, wherein the variance in the operation of the tunable wavelength demultiplexer is caused by manufacturing, mechanical stress, temperature, aging, or combinations thereof experienced by the one or more devices.

8. The method of claim 6, wherein the one or more devices comprises one or more multimode interference (MMI) devices.

9. The method of claim 1, wherein the phase shift adjustment is performed by a phase shifter within the tunable wavelength demultiplexer to reduce the crosstalk between the first optical signal and the second optical signal.

10. The method of claim 9, wherein the phase shifter corresponds to a thermal phase shifter (TPS), carrier injection phase shifter, electrooptic phase shifter, carrier depletion phase shifter, or combinations thereof, and wherein a setting of the phase shifter is stored and used by the demultiplexer controller as an initial configuration of the phase shifter.

11. The method of claim 1, further comprising:
processing the first optical signal by a first optical circuit and a first photodetector to produce a first signal supplied to a first transimpedance amplifier (TIA), wherein the first optical circuit is coupled to a first local oscillator operating at the first wavelength;
processing the second optical signal by a second optical circuit and a second photodetector to produce a second signal supplied to a second TIA, wherein the second optical circuit is coupled to a second local oscillator operating at the second wavelength; and
wherein the detecting, comprises monitoring the first TIA and the second TIA to detect the crosstalk between the first optical signal and the second optical signal.

12. The method of claim 1, further comprising:
receiving, by an optical receiver circuit, optical signals having a transverse electric component and a transverse magnetic component;
processing, by the optical receiver circuit, the optical signals to generate the processed optical signals.

13. The method of claim 12, wherein the processed optical signals comprise a first transverse electric optical signal and a second transverse electric optical signal, wherein the first transverse electric optical signal is generated from the transverse electric component, and wherein the second transverse electric optical signal is generated from the transverse magnetic component.

14. The method of claim 13, wherein the optical modem comprises a first optical modem and a second optical modem each configured to perform the receiving, the separating, the detecting and the performing steps, and wherein the first transverse electric optical signal is supplied to the first optical modem, and wherein the second transverse electric optical signal is supplied to the second optical modem.

15. An optical modem, comprising:
a tunable optical separator configured to separate optical signals into distinct wavelengths resulting in a first optical signal having a first wavelength and a second optical signal having a second wavelength; and
a controller performing operations including:
detecting crosstalk between the first optical signal and the second optical signal caused by a variance in an operation of the tunable optical separator; and
performing an adjustment of the tunable optical separator to reduce the crosstalk.

16. The optical modem of claim 15, wherein the tunable optical separator comprises a tunable wavelength demultiplexer, wherein the adjustment is a phase shift adjustment performed on the tunable wavelength demultiplexer, and wherein the performing comprises:
monitoring, by the demultiplexer controller, a first control signal directed to a first amplifier;
monitoring, by the demultiplexer controller, a second control signal directed to a second amplifier;
determining, by the demultiplexer controller, a stability state of the first control signal and the second control signal; and
performing, by the demultiplexer controller, the phase shift adjustment of the tunable wavelength demultiplexer when the stability state indicates a steady-state condition has been reached.

17. The optical modem of claim 15, wherein the tunable optical separator comprises a tunable wavelength demultiplexer, wherein the adjustment is a phase shift adjustment performed on the tunable wavelength demultiplexer, and wherein the performing comprises:
receiving, by the demultiplexer controller, a first detection signal from a first amplifier;
receiving, by the demultiplexer controller, a second detection signal from a second amplifier; and
performing, by the demultiplexer controller, the phase shift adjustment of the tunable wavelength demultiplexer according to the first detection signal and the second detection signal.

18. A non-transitory machine-readable medium, comprising executable instructions that, when executed by a processing system including a processor, facilitate performance of operations, the operations comprising:
detecting crosstalk between a first optical signal and a second optical signal produced by a tunable wavelength demultiplexer that separates optical signals into distinct wavelengths, the crosstalk attributed to a variance in an operation of the tunable wavelength demultiplexer; and
applying a phase shift adjustment of the tunable wavelength demultiplexer to reduce the crosstalk.

19. The non-transitory machine-readable medium of claim 18, wherein the applying comprises:
monitoring a first control signal directed to a first amplifier;
monitoring a second control signal directed to a second amplifier;
determining a stability state of the first control signal and the second control signal; and
applying the phase shift adjustment of the tunable wavelength demultiplexer when the stability state indicates a steady-state condition has been reached.

20. The non-transitory machine-readable medium of claim 18, wherein the applying comprises:
receiving a first detection signal from a first amplifier;
receiving a second detection signal from a second amplifier; and
applying the phase shift adjustment of the tunable wavelength demultiplexer according to the first detection signal and the second detection signal.
